(19) United States
(12) Patent Application Publication
(10) Pub. No.: US 2012/0174031 A1
(43) Pub. Date: Jul. 5, 2012

(54) CLICKLESS GRAPHICAL USER INTERFACE

(75) Inventors: MEHMET DONDURUR, DHAHRAN (SA); AHMET Z. SAHIN, DHAHRAN (SA)

(73) Assignee: KING FAHD UNIVERSITY OF PETROLEUM AND MINERALS, DHAHRAN (SA)

(21) Appl. No.: 12/985,165

(22) Filed: Jan. 5, 2011

(51) Int. Cl. G06F 3/048

(52) U.S. Cl. 715/808

(57) ABSTRACT

The clickless graphical user interface provides a pop-up window when a cursor is moved over designated areas on the screen. The pop-up window includes menu item choices, e.g., “double click”, “single click”, “close” that execute when the cursor is moved over the item. This procedure eliminates the traditional ‘mouse click’, thereby allowing users to move the cursor over the application or file and open it by choosing among the aforementioned choices in the file or application being focused on. The pop-up window shows the navigation choices in the form of a text, e.g., yes/no or color, e.g., red/blue, or character, such as triangle for ‘yes’ and square for ‘no’. Pop-up window indicator types are virtually unlimited and can be changed to any text, color or character. The method is compatible with touch pads and mouses.

### BACKGROUND OF THE INVENTION

1. Field of the Invention

The present invention relates to a graphical user interface (GUI), and more particularly to a clickless graphical user interface (GUI) that eliminates the need for mouse clicks for activation of objects pointed to by a cursor.

2. Description of the Related Art

Many computer operating systems on personal computers, desktops, notebooks, and laptops have a graphical interface that utilizes clickable icons and menus on the computer screen. To input commands to the computer, a user commonly uses a mouse to move a cursor over an object of interest on the screen, and then physically clicks on an appropriate mouse button to activate an icon, button, web page link, drag-down menu, or the like associated with the object of interest pointed to by the cursor. The trend of using mouse-clicks for input appears likely to continue into the future, as it has become ingrained into the way we interact with our computers.

Clicking on a mouse button requires a certain nimbleness in the user's fingers, especially for such operations as double-clicks (in which the user clicks on the mouse button twice in rapid succession), drag-and-drops (in which the user clicks and holds the mouse button, moves the cursor and then releases the mouse button), copy-and-paste (in which the cursor is moved to the beginning of the text, the mouse button held down, and the cursor dragged across the text to be marked), and even triple-clicks (in which the user presses the button three times in quick succession, most commonly seen in word processors and web browsers to select a whole section of text). However, a clumsy user or one who is suffering from arthritis or other ailments of the finger joints may lack the capacity to perform these actions, which may be required to operate the computer properly.

Studies have shown that a user may click the mouse button more than two million times a year. Users are beginning to tire of the same old interfacing methodologies, which strain users' digits. There is a long felt need for a better methodology for using graphical user interfaces.

Thus, a clickless graphical user interface solving the aforementioned problems is desired.

### SUMMARY OF THE INVENTION

The clickless graphical user interface provides a pop-up window when a cursor is moved over designated areas on the screen. The pop-up window includes choices, e.g., “double click”, “single click”, “close” that execute when a mouse is moved over the menu item. This procedure eliminates the traditional ‘mouse click’, thereby allowing users to move the cursor over the application or file and open it by choosing among the aforementioned choices in the file or application being focused on.

The pop-up window shows the navigation choices in the form of a text (yes/no) or color (Red/blue), or character (such as triangle for ‘yes’ and square for ‘no’). Pop-up window indicator types are unlimited and can be changed to any text, color or character. Thus, clickless file navigation is provided. The method is easier to use, faster to navigate, and eliminates the noise of the mouse click. The method is compatible with touch pads and mouses.

These and other features of the present invention will become readily apparent upon further review of the following specification and drawings.

### BRIEF DESCRIPTION OF THE DRAWINGS

FIG. 1 is a screen shot showing a text-based embodiment of a clickless graphic user interface according to the present invention.

FIG. 2 is a screen shot showing a color-based embodiment of the clickless graphic user interface according to the present invention.

FIG. 3 is a screen shot showing a color-based embodiment of the clickless graphic user interface according to the present invention.

Similar reference characters denote corresponding features consistently throughout the attached drawings.

### DETAILED DESCRIPTION OF THE PREFERRED EMBODIMENTS

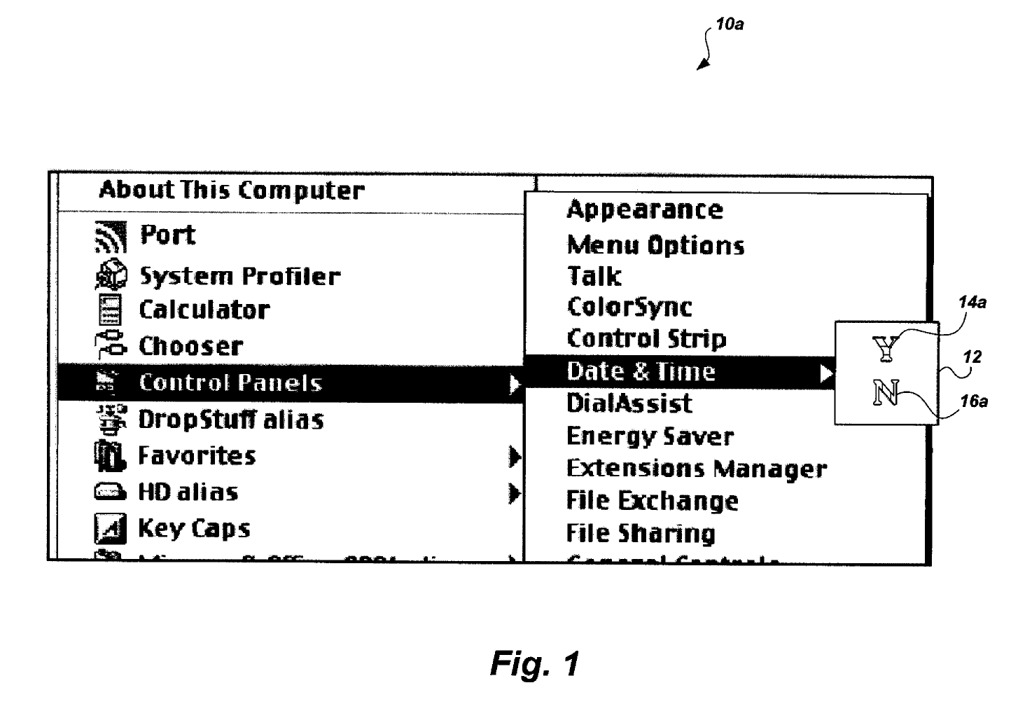

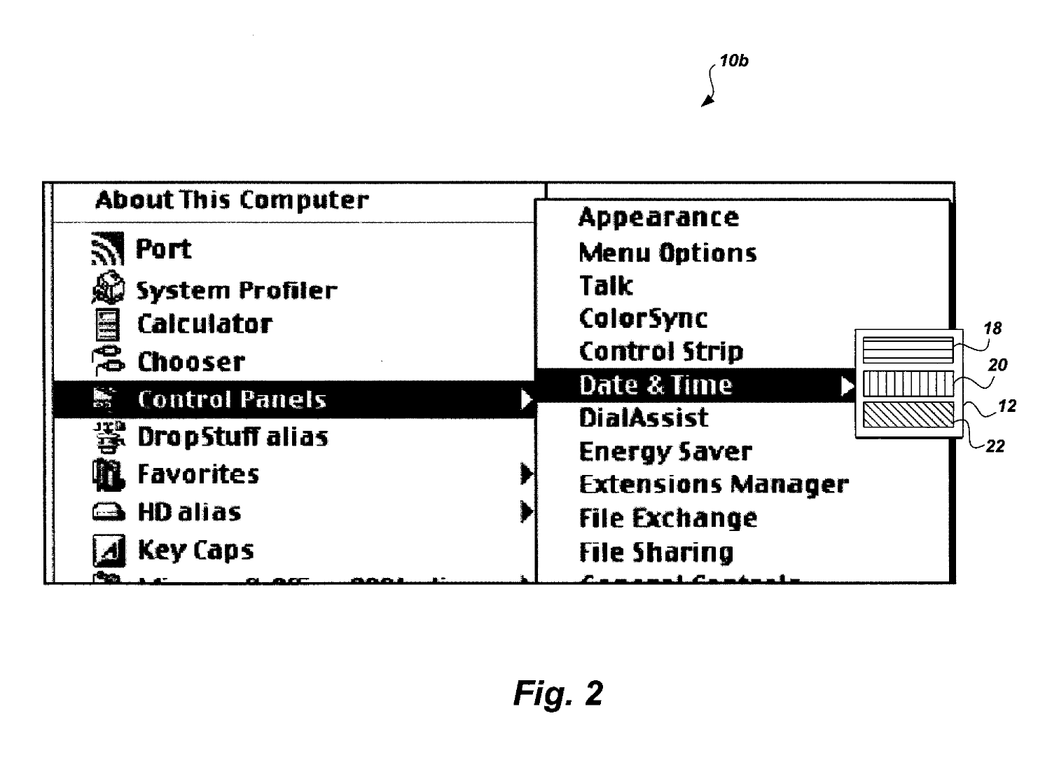

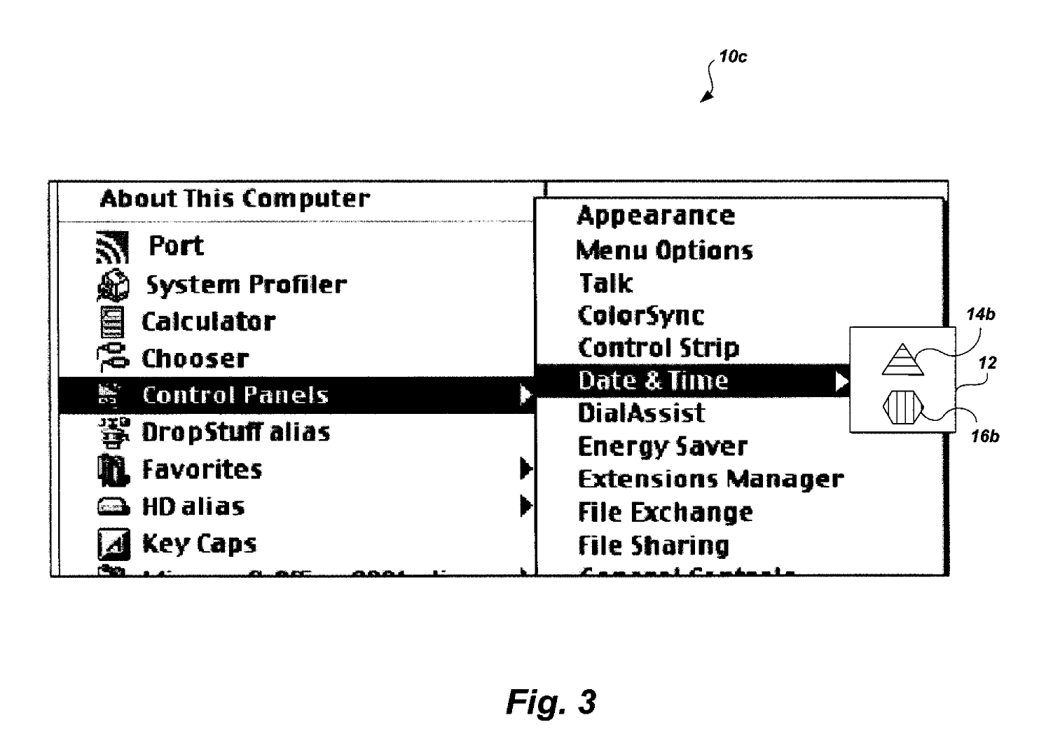

The clickless graphical user interface has been developed in a text-based embodiment of a clickless graphical user interface 10a (shown in FIG. 1), a color-based embodiment of a clickless graphical user interface 10b (shown in FIG. 2), and a shape-based embodiment of a clickless graphical user interface 10c (shown in FIG. 3), which provide a pop-up window or pop-up menu when a cursor is moved over designated areas on the screen (it will be understood that “moved over” means moving the cursor and retaining the cursor in the desired position for a predetermined period of time), e.g., by moving a mouse. The pop-up window 12 includes a choice of menu items, e.g., “double click”, “single click”, “close”, etc., that execute when the cursor is when moved over the item. This procedure eliminates the traditional ‘mouse click,’ thereby allowing users to move the cursor over the application or file and open it by choosing among the aforementioned menu item choices provided for the file or application being focused on.

As shown in FIG. 1, the pop-up window 12 can display the navigation choices in the form of a text (Y 14a for yes/N 16a for no), Y 14a causing the file or application to open, and N 16a causing the file or application to close or go back or cancel an action. Instead of “Y” and “N”, the menu items may be the words “Open”, “Close”, and “Cancel”, or any other descriptive word or phrase suitable to the context.

As shown in FIG. 2, the pop-up window 12 can display the navigation choices in the form of colors e.g., red 20, green 22, or blue 18, where blue 18 is used to open an application, file or folder, red 20 is used to close, and green 22 is used to cancel an action.

As shown in FIG. 3, the pop-up window 12 can display the navigation choices in the form of iconic indicia distinguished by the shape of the icon or symbol, e.g., triangle 14b for ‘yes’ and hexagon 16b for ‘no’.

The pop-up window indicator types of 10a, 10b, and 10c are virtually unlimited and can be changed to any text, color, character, or visual indicia. Thus, clickless file navigation is provided. The method is easier to use, faster to navigate, and eliminates the noise of a mouse click. The method is compatible with touch pads and mouses. Thus, navigation style is reflected in the type of text, color or shape used, and the final action choice reflects the functionality to finalize a navigation action initiated by the user positioning of a cursor on an object, item, or visual image displayed on the screen.

To operate or open an item, a user merely moves the mouse or a touch in a touch screen over any item, and this user action causes a hierarchal pop-up window 12 or pop-up menu to display text (Y 14a/N 16a or OPEN/CANCEL etc), or a color (R 18, G 20, or B 22) or graphic iconic indicia, e.g. triangle 14b or hexagon 16b to open a file. The user then moves the mouse cursor over a choice, such as OPEN/CANCEL or Y/N text or color icon (Red for close, Blue for Open), or shape (small characters or shapes to open and close) to open or cancel the open action for opening file or application. To close an already open file or application, the user moves the cursor over the title bar of the window, which causes a small action window to popup to close or cancel the close action. The clickless graphical user interface can be used for all GUI-based operating systems, such as Mac OSX, Windows, Linux, or the like. Moreover, the clickless method may be used for any software application utilizing a no click concept, including Web tools and applications.

It will be understood that the diagrams in the Figures depicting the clickless graphical user interface are exemplary only, and may be embodied in a dedicated electronic device having a microprocessor, microcontroller, digital signal processor, application specific integrated circuit, field programmable gate array, any combination of the aforementioned devices, or other device that combines the functionality of the clickless graphical user interface onto a single chip or multiple chips programmed to carry out the method steps described herein, or may be embodied in a general purpose computer having the appropriate peripherals attached thereto and software stored on a computer readable media that can be loaded into main memory and executed by a processing unit to carry out the functionality of the apparatus and steps of the method described herein.

It is to be understood that the present invention is not limited to the embodiments described above, but encompasses any and all embodiments within the scope of the following claims.

We claim:

1. A computer-implemented clickless graphical user interface method for interfacing a user with a display device, the method comprising the steps of:
displaying a pop-up window when a cursor is moved over an object on the display device;
displaying a plurality of menu item choices in the pop-up window, the choices representing alternate computer actions related to the object; and
activating a specific one of the object related alternate computer actions corresponding to cursor placement of the cursor over the specific one of the menu item choices solely in response to cursor position.

2. The computer-implemented clickless graphical user interface method according to claim 1, wherein said step of displaying a plurality of menu items comprises the step of displaying unique text representing each of the menu item choices presented to the user.

3. The computer-implemented clickless graphical user interface method according to claim 1, wherein said step of displaying a plurality of menu items comprises the step of displaying unique color schemes representing each of the menu item choices presented to the user.

4. The computer-implemented clickless graphical user interface method according to claim 1, wherein said step of displaying a plurality of menu items comprises the step of displaying unique iconic shape indicia representing each of the menu item choices presented to the user.

5. The computer-implemented clickless graphical user interface method according to claim 1, wherein the alternate computer actions related to the object are OPEN, CLOSE, or CANCEL.

6. The computer-implemented clickless graphical user interface method according to claim 1, wherein said object is a file.

7. The computer-implemented clickless graphical user interface method according to claim 1, wherein said object is an application.

8. The computer-implemented clickless graphical user interface method according to claim 1, wherein said object is the title bar of a window.

9. A computer software product, comprising a medium readable by a processor, the medium having stored thereon a set of instructions for establishing a clickless graphical user interface, the set of instructions including:
(a) a first sequence of instructions which, when executed by the processor, causes said processor to display a pop-up window when a cursor is placed over an object on the display device;
(b) a second sequence of instructions which, when executed by the processor, causes said processor to display a plurality of choices in said pop-up window, the choices representing alternate computer actions related to the object; and
(c) a third sequence of instructions which, when executed by the processor, causes said processor to activate a specific one of the object related alternate computer actions corresponding to cursor placement of the cursor over the specific one of the menu item choices solely in response to cursor position.

10. The computer software product according to claim 9, wherein said second sequence of instructions further comprises displaying unique text representing each of the menu item choices presented to the user.

11. The computer software product according to claim 9, wherein said second sequence of instructions further comprises displaying unique color schemes representing each of the menu item choices presented to the user.

12. The computer software product according to claim 9, wherein said second sequence of instructions further comprises displaying unique iconic shape indicia representing each of the menu item choices presented to the user.

13. The computer software product according to claim 9, wherein the alternate computer actions related to the object are OPEN, CLOSE, or CANCEL.

14. The computer software product according to claim 9, wherein said object is a file.

15. The computer software product according to claim 9, wherein said object is an application.

16. The computer software product according to claim 9, wherein said object is the title bar of a window.
